(19) United States
(12) Patent Application Publication
(10) Pub. No.: US 2009/0101732 A1
(43) Pub. Date: Apr. 23, 2009

(54) Airbrush

(76) Inventor: You-Cheng LIAO, Taichung City (TW)

Correspondence Address: Dr. BANGER SHIA, 102 Lindencrest Ct., Sugar Land, TX, 77479-5201, US

(21) Appl. No.: 11/874,115

(22) Filed: Oct. 17, 2007

(51) Int. Cl. B05B 9/03

(52) U.S. Cl. 239/310

(57) ABSTRACT

An airbrush includes a can, a cover, a spraying device and a blending device. The can includes an open upper end and an open lower end. The cover is connected to the open upper end of the can. The spraying device is mounted on the cover so that the spraying device is in communication of fluid with the can through the cover. The blending device is connected to the open lower end of the can and operable to blend paint contained in the can without having to open the can.

### BACKGROUND OF INVENTION

1. Field of Invention

The present invention relates to an airbrush and, more particularly, to an airbrush including a can, a spraying device and a blending device.

2. Related Prior Art

Referring to FIG. 1, a conventional airbrush includes a can 10 and a spraying device 20. A cover 15 is mounted on an open upper end 11 of the can 10. The spraying device 20 is formed with a joint 25 connected to a pipe 16 extended from the cover 15. Paint is contained in the can 10 and can be sprayed from the spraying device 20. There is however a serious problem with this conventional airbrush. The paint is often a mixture of several ingredients of different colors. Before use, the ingredients are blended so that a desired color of the paint of is obtained. However, the ingredients start to separate from one another once the spraying stops. A user therefore has to blend the ingredients from time to time. To blend the ingredients, the cover 15 is detached from the open upper end 11 of the can 10. A rod or the like is inserted into the can 10 and operated to blend the ingredients. The rod is removed from the can 10. Finally, the cover 15 is mounted on the open upper end 11 of the can 10 again. This process is inconvenient. Moreover, the paint that sticks to the rod might drop and stain the working environment.

The present invention is therefore intended to obviate or at least alleviate the problems encountered in prior art.

### SUMMARY OF INVENTION

According to the present invention, an airbrush includes a can, a cover, a spraying device and a blending device. The can includes an open upper end and an open lower end. The cover is connected to the open upper end of the can. The spraying device is mounted on the cover so that the spraying device is in communication of fluid with the can through the cover. The blending device is connected to the open lower end of the can and operable to blend paint contained in the can without having to open the can.

An advantage of the airbrush according to the present invention is convenience since the paint is blended without having to open the can.

Another advantage of the airbrush according to the present invention is clarity in the working environment because the can is always closed when the paint is blended.

Other advantages, objectives and features of the present invention will become apparent from the following description referring to the attached drawings.

### BRIEF DESCRIPTION OF DRAWINGS

The present invention will be described via detailed illustration of the preferred embodiment against prior art referring to the drawings.

FIG. 1 is a side view of a conventional airbrush.

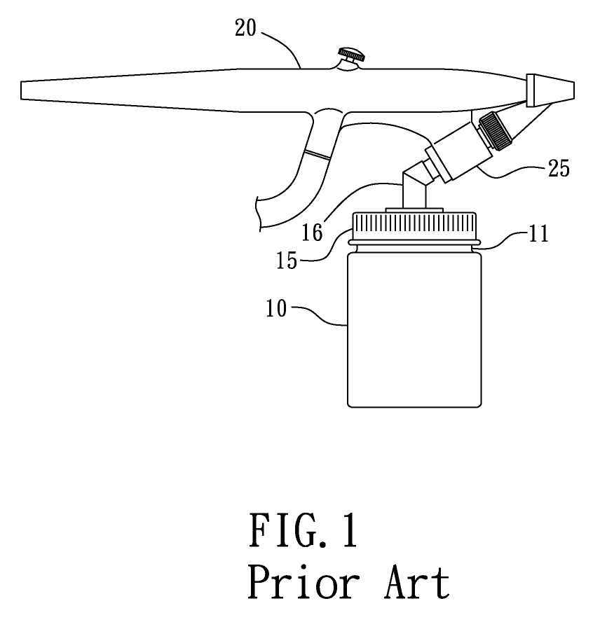

FIG. 2 is a side view of an airbrush including a can, a spraying device and a blending device according to the preferred embodiment of the present invention.

FIG. 3 is an exploded view of the can and the blending device shown in FIG. 2.

FIG. 4 is an exploded view of the blending device shown in FIG. 3.

FIG. 5 is another exploded view of the blending device of FIG. 4.

FIG. 6 is partial cross-sectional view of the airbrush shown in FIG. 2.

FIG. 7 is another cross-sectional view of the airbrush shown in FIG. 6.

### DETAILED DESCRIPTION OF PREFERRED EMBODIMENT

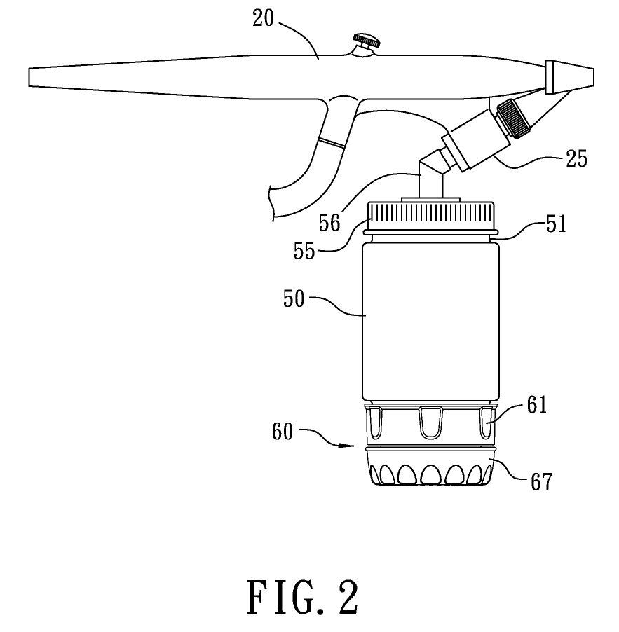

Referring to FIG. 2, an airbrush includes a can 50, a spraying device 20 and a blending device 60 according to the preferred embodiment of the present invention. A cover 55 is mounted on an open upper end 51 of the can 50. The spraying device 20 includes a joint 25 connected to a tube 56 extended from the cover 55. The spraying device 20, the open upper end 51 of the can 50 and the cover 55 are conventional and therefore will not be described in detail. The blending device 60 is used to blend paint contained in the can 50 and will be described in detail.

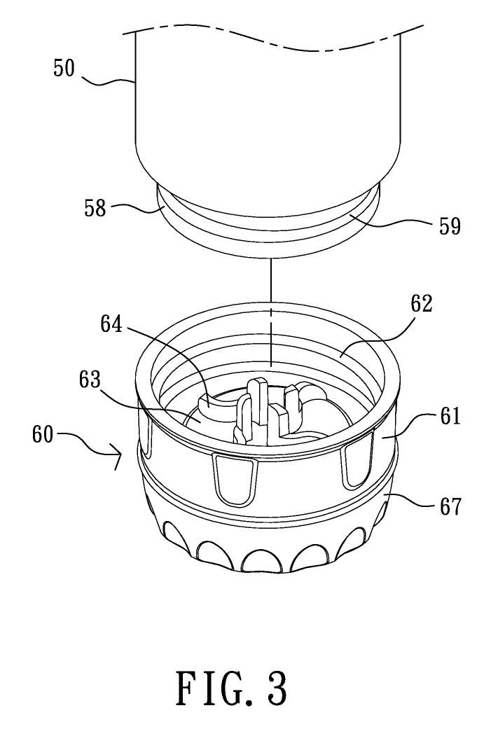

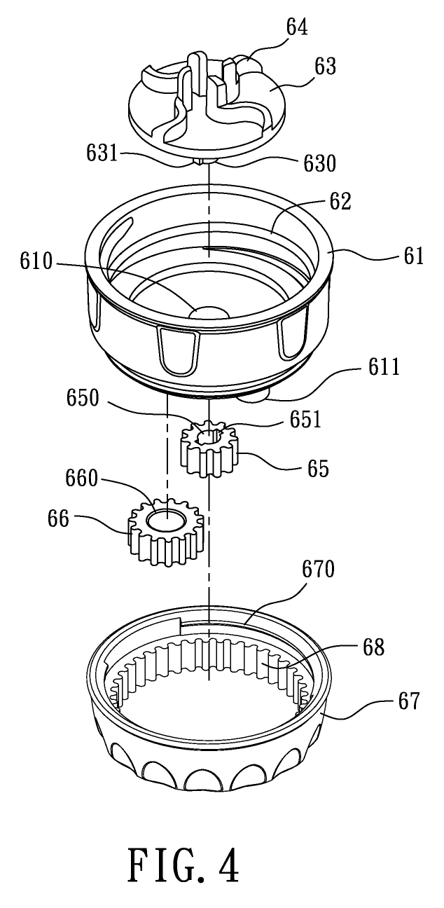

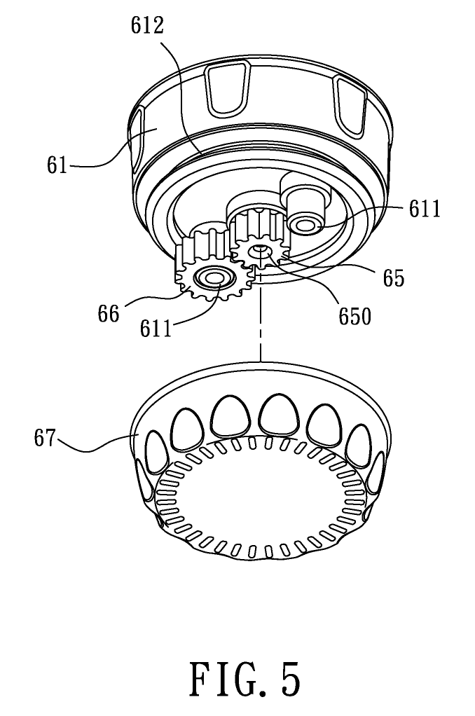

Referring to FIGS. 3 through 7, the can 50 included an open lower end 58 and a thread 59 formed on an external side of the open lower end 58 of the can 50.

The blending device 60 includes a ring 61, a rotor 63, a knob 67, a pinion 65 and a gear 66. The ring 61 includes a thread 62 formed on an internal side thereof, a bushing 610 extended axially from the bottom thereof, at least one axle 611 extended from the bottom thereof and a groove 612 defined in an external side thereof. The thread 62 is engaged with the thread 59 so that the ring 61 is attached to the can 50.

The rotor 63 includes four blades 64 formed on the top thereof and an axle 630 extended axially from the bottom thereof. The axle 630 includes two keys 631 formed on the periphery thereof. The rotor 63 is disposed in the ring 61. The axle 630 is inserted through the bushing 610 so that the keys 631 are exposed from the ring 61. Two seals 632 are mounted on the axle 630 so that the paint cannot leak between the axle 630 and the bushing 610.

The pinion 65 includes an aperture 650 centrally defined therein and two mortises 651 defined therein. The pinion 65 is mounted on the axle 630. That is, the axle 630 is inserted in the aperture 650 while the keys 631 are disposed in the mortises 651. Thus, the axle 630 can be rotated together with the pinion 65.

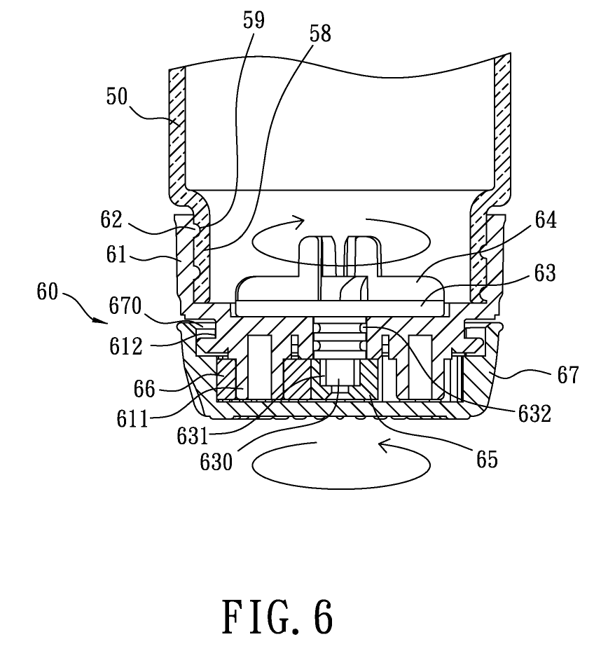

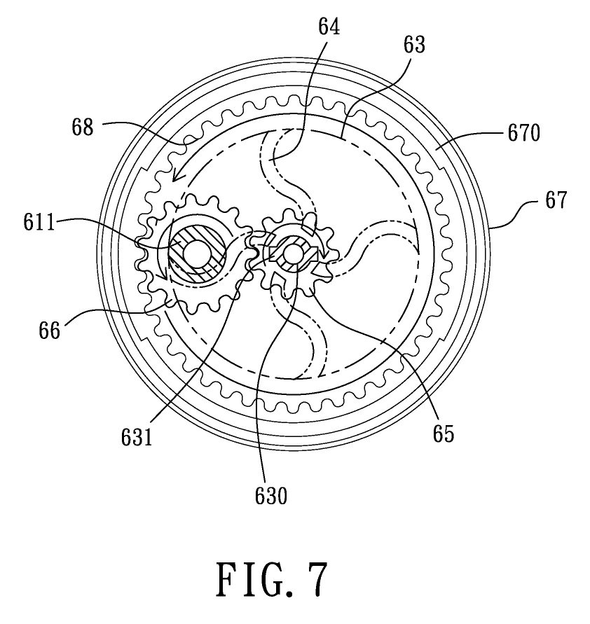

The gear 66 includes an aperture 660 centrally defined therein for receiving the axle 611 so that the gear 66 is rotationally mounted on the axle 611. The gear 66 is engaged with the pinion 65 as best shown in FIGS. 6 and 7.

The knob 67 includes a ridge 670 formed on an internal side thereof and an annular rack 68 formed on the internal side thereof. The ridge 670 is disposed in the groove 612 so that the knob 67 is rotationally attached to the ring 61. The annular rack 68 is engaged with the gear 66 as best shown in FIGS. 6 and 7.

In use, the knob 67 is operated and, more particularly, rotated. The annular rack 68 drives the gear 66. The gear 66 drives the pinion 65. The pinion 65 drives the axle 630. The axle 630 drives the blades 64. The blades 64 blend the paint.

The airbrush according to the present invention exhibits several advantages for using the blending device 60. Firstly, the blending of the paint is convenient because only the knob 67 is operated.

Secondly, the blending of the paint is effective because the blades 64 rotate quickly and blend the paint well.

Thirdly, the working environment is clean because the can 50 is closed during the blending of the paint.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An airbrush comprising:
a can comprising an open upper end and an open lower end;
a cover connected to the open upper end of the can;
a spraying device mounted on the cover so that the spraying device is in communication of fluid with the can through the cover;
a blending device connected to the open lower end of the can and operable to blend paint contained in the can without having to open the can.

2. The airbrush according to claim 1 wherein the blending device comprises:
a ring connected to the open lower end of the can;
a knob rotationally connected to ring; and
a rotor formed with at least one blade, disposed in the ring and connected to the knob so that the blade blends the paint when the rotor rotates together with the knob.

3. The airbrush according to claim 2 wherein the can comprises a thread formed on an external side of the open lower end thereof, and the ring comprises a thread formed on an internal side thereof and engaged with the thread of the can.

4. The airbrush according to claim 2 wherein the one of the ring and knob comprises a groove defined therein, and the other of the ring and knob comprises an edge formed thereon and disposed in the groove.

5. The airbrush according to claim 2 wherein the ring comprises a bushing extended from the bottom thereof, and the rotor comprises an axle extended from the bottom thereof, inserted through the bushing and connected to the knob.

6. The airbrush according to claim 5 comprising:
a pinion mounted on the axle so that the pinion can rotate together with the axle; and
a gear rotationally connected to the ring and engaged with the pinion, wherein the knob comprises an annular rack formed on an internal side thereof and engaged with the gear.

7. The airbrush according to claim 6 wherein the ring comprises an axle extended from the bottom thereof, and the gear is rotationally mounted on the axle of the ring.

8. The airbrush according to claim 6 wherein the axle of the rotor comprises at least one key formed thereon, and the pinion comprises at least one mortise for receiving the key.

9. The airbrush according to claim 5 comprising at least one seal mounted on the axle.
